(19) United States
(12) Patent Application Publication
(10) Pub. No.: US 2025/0245387 A1
(43) Pub. Date: Jul. 31, 2025

(54) VEHICLE ACCESS CONTROL SYSTEM AND ACCESS CONTROL METHOD

(71) Applicant: Panasonic Automotive Systems Co., Ltd., Kanagawa (JP)

(72) Inventor: Jun ANZAI, Kanagawa (JP)

(73) Assignee: Panasonic Automotive Systems Co., Ltd., Kanagawa (JP)

(21) Appl. No.: 19/029,989

(22) Filed: Jan. 17, 2025

(30) Foreign Application Priority Data
Jan. 30, 2024 (JP) 2024-011923
Apr. 3, 2024 (JP) 2024-059917

(51) Int. Cl. G06F 21/74

(52) U.S. Cl. CPC G06F 21/74

(57) ABSTRACT

Vehicle access control system is provided in a vehicle, and includes first access controller, second access controller, and third access controller. First access controller controls communication in a first area of a segment including a plurality of areas. Second access controller controls communication in a second area of the segment. Third access controller controls communication in a third area different from the first area and the second area and has a function to convert a communication protocol. First access controller causes the third area to relay a message transmitted from the first area to the second area.

### CROSS REFERENCE TO RELATED APPLICATIONS

The present application is based on and claims priority of Japanese Patent Application No. 2024-011923 filed on Jan. 30, 2024, and Japanese Patent Application No. 2024-059917 filed on Apr. 3, 2024.

### FIELD

The present disclosure relates to a vehicle access control system, and so on, provided in a vehicle.

### BACKGROUND

Due to the evolution of on-vehicle architectures, the shift progresses from current gateway architectures to domain controller (DC) architectures. Integrating the functions of a plurality of electronic control units (ECUs) into one ECU using a virtualization technique is applied to DCs. An increasing number of vehicles include software updatable by paid upgrades with a software defined vehicle (SDV), the incorporation of a third-party application, or other suitable means, even after the user has purchased the vehicle. In this manner, with an improvement of the user convenience, an increasing amount of information transmitted within the vehicle are believed to be used and utilized rapidly.

Each of DCs generates the data necessary for service. The DCs exchange data. The inside of each DC is divided into a plurality of areas by virtualization or other techniques. Each of the areas generates data. For control, each DC utilizes data not only from the DC itself but also from other DCs. Here, each area refers to a range in which a certain type of data may exist. Instead of being divided by a virtualization platform, areas may be on a program-by-program basis, such as an application-by-application basis or a process-by-process basis, provided by an operating system (OS) or may be cores of a multicore central processing unit (CPU).

In view of this background, the protection of personal information under laws and regulations of each country is required. In order to achieve data control not only between the inside and the outside of the vehicle but also between services, not only simply managing data between a plurality of DCs but also managing data between a plurality of areas is necessary.

In recent years, in the field of information and communications, access control systems have been considered which allow normal messages to pass and block attacks in communication access control.

For example, Patent Literature (PTL) 1 discloses grouping a plurality of hosts into several domains and performing access control.

### CITATION LIST

### Patent Literature

PTL 1: International Patent Publication No. WO 2022/118395

### SUMMARY

However, the technique according to PTL 1 can be improved upon.

In view of this, the present disclosure provides a vehicle access control system, and so on, capable of improving upon the above related art.

A vehicle access control system according to an aspect of the present disclosure is provided in a vehicle. The vehicle access control system includes: a first access controller that controls communication in a first area of a segment including a plurality of areas; a second access controller that controls communication in a second area of the segment; and a third access controller that controls communication in a third area different from the first area and the second area and has a function to convert a communication protocol. The first access controller causes the third area to relay a message transmitted from the first area to the second area.

An access control method according to an aspect of the present disclosure is executed by a vehicle access control system provided in a vehicle. The vehicle access control system controls communication in a first area of a segment including a plurality of areas. The vehicle access control system controls communication in a second area of the segment. The vehicle access control system controls communication in a third area different from the first area and the second area through a function to convert the communication protocol. The vehicle access control system causes the third area to relay a message transmitted from the first area to the second area.

A program according to an aspect of the present disclosure is for causing one or more processors to execute the access control method.

The technique vehicle access control system according to the present disclosure can be improved upon.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram showing an example functional configuration of a vehicle access control system according to an embodiment.

FIG. 2 shows example segments.

FIG. 3 shows example communication data.

FIG. 4 shows example conversion data.

FIG. 5 is a block diagram showing a first communication example of the vehicle access control system according to the embodiment.

FIG. 6 is a block diagram showing a second communication example of the vehicle access control system according to the embodiment.

FIG. 7 is a sequence diagram showing the second communication example of the vehicle access control system according to the embodiment.

FIG. 8 shows an example policy for use in the second communication example of the vehicle access control system according to the embodiment.

FIG. 9 is a block diagram showing a third communication example of the vehicle access control system according to the embodiment.

FIG. 10 is a sequence diagram showing the third communication example of the vehicle access control system according to the embodiment.

FIG. 11 shows an example policy for use in the third communication example of the vehicle access control system according to the embodiment.

FIG. 12 is a block diagram showing an example functional configuration of a vehicle access control system according to a variation of the embodiment.

### DESCRIPTION OF EMBODIMENT

### (Underlying Knowledge Forming Basis of the Present Disclosure)

The present inventor found that the technique according to PTL 1 described in “Background” section has a problem described below.

Some on-vehicle systems include a plurality of typical ECUs and DCs mixed together. Even in such an on-vehicle system in which a plurality of ECUs (including DCs) exist and software is updated dynamically, separating an entry point (EP) connected to the outside from the safety functions of the vehicle, what is called “segment separation” is necessary.

On-vehicle systems can ensure a plurality of communication protocols, such as communications using the Ethernet or communications between virtual machines (VMs) on virtualization platforms in combination, in addition to the control area network (CAN) communication or the serial communication. In such an on-vehicle system, when transmitting and receiving data between a plurality of areas, logically separating the areas into a plurality of segments is conceivable.

Each segment includes one or more areas and is defined for a message (data) type, such as personal information, corporate information, or travel control information. A message associated with a certain segment can exist within the segment. In principle, transmitting the message outside the segment is not allowed. On the other hand, temporarily transmitting information outside of the segment may be allowed, if some conditions are met. In order to achieve such segment separation, applying security policies to the functions for communications between the plurality of areas is necessary. Security policies include rules for allowing transmission of a specific type of message from one to the other of two areas, for example.

The technique disclosed in PTL 1 however groups a plurality of hosts under one communication protocol, such as the Ethernet, and cannot handle the segment separation in on-vehicle systems assuming the employment of a plurality of communication protocols.

To address the problem, the present disclosure provides a vehicle access control system that can apply segment separation to an on-vehicle system assuming the employment of a plurality of communication protocols.

Now, an embodiment will be described in detail with reference to the drawings.

Note that the embodiment described below is a mere comprehensive and specific example of the present disclosure. The numerical values, shapes, materials, elements, the arrangement and connection of the elements etc. shown in the following embodiment are thus mere examples, and are not intended to limit the scope of the present disclosure.

### EMBODIMENT

Now, a vehicle access control system according to the embodiment will be described.

### 1. Configuration of Vehicle Access Control System

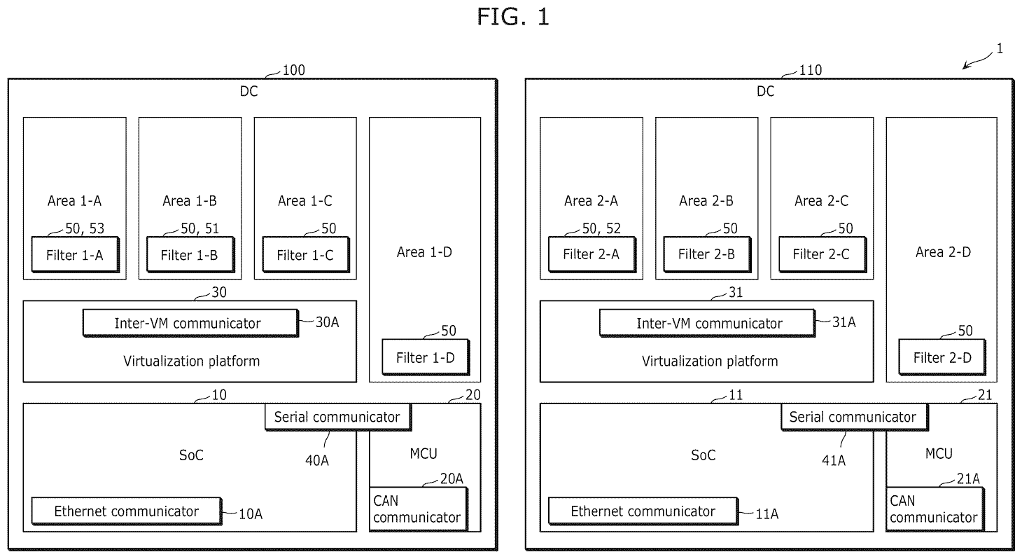

FIG. 1 is a block diagram showing an example functional configuration of vehicle access control system 1 according to the embodiment. Vehicle access control system 1 is provided in a vehicle (i.e., an example of a mobility unit). Vehicle access control system 1 controls communications of a plurality of segments logically separated into a plurality of areas.

For example, each segment includes a plurality of areas each allowing the presence of a message in accordance with the message (i.e., data) type. Here, each area is a division with a microcontroller or a virtual machine regarded as one unit in a device, such as an ECU (including a DC). Note that each area may be a division with an application or a service level (i.e., a process) regarded as one unit. Since each segment is defined in accordance with the message type, a certain area may belong to a plurality of segments. A plurality of areas may belong to the same segment in the same ECU, the areas of a plurality of different ECUs may belong to the same segment. That is, each segment may include one or more areas in one ECU (including DC). For example, if a first DC and a second DC exist in a vehicle, the area of the first DC and the area of the second DC may form one segment.

Each segment may be defined by defining a plurality of areas belonging to the segment in accordance with the segment type. In this case, a message type is defined within the segment in accordance with the segment type, and the message cannot exist in other segments in principle. For example, a message being “Privacy information” can exist in the “Privacy” segment, but cannot exist in the “Safety” segment in principle.

Being prohibited in principle, communications between a plurality of different segments may be allowed depending on restrictions or conditions.

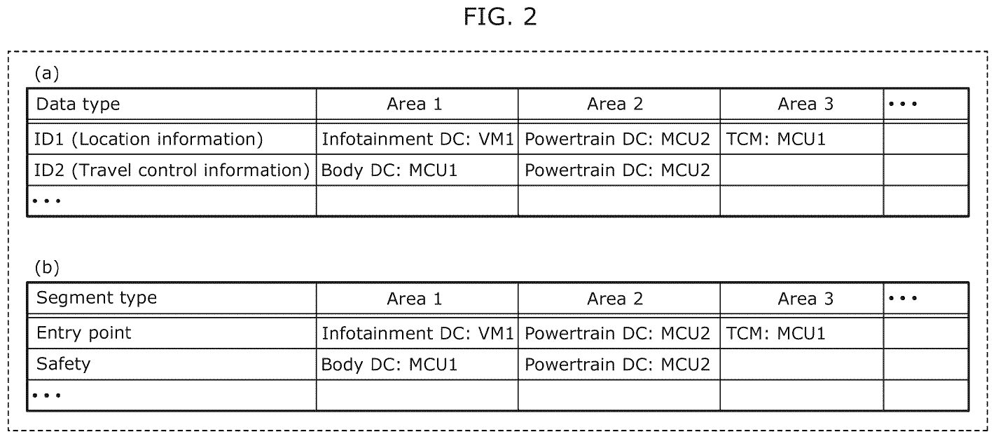

FIG. 2 shows example segments. In FIG. 2, (a) shows a first example of a segment, and (b) shows a second example of a segment. In FIG. 2, “DC” represents a domain controller, “MCU” represents a micro controller unit (or simply a microcontroller), and “VM” represents a virtual machine. The term “TCU” in FIG. 2 represents a telematics control unit.

In the first example, each segment is defined in accordance with a message type. In the example shown in (a) of FIG. 2, the area “Infotainment-DC: VM 1”, the area “Powertrain-DC: MCU 2”, and the area “TCU: MCU 1” belong to the segment of the message type “Location information”. On the other hand, the area “Body-DC: MCU 1” and the area “Powertrain-DC: MCU 2” belong to the segment of the message type “Travel control information”. In the example shown in (a) of FIG. 2, the area “Powertrain-DC: MCU 2” belong to two segments.

In the second example, each segment is defined by defining one or more areas belonging to the segment in accordance with the segment type. In the example shown in (b) of FIG. 2, the area “Infotainment-DC: VM 1”, the area “Powertrain-DC: MCU 2”, and the area “TCU: MCU 1” belong to the segment of the segment type “Entry Point”. On the other hand, the area “Body-DC: MCU 1” and the area “Powertrain-DC: MCU 2” belong to the segment of the segment type “Safety”. In the example shown in (b) of FIG. 2 as well, the area “Powertrain-DC: MCU 2” belong to two segments.

Although not shown in the figure, the segment of “Entry Point” allows the existence of the message of the message type “Location information”, and the segment of “Safety” allows the existence of the message of the message type “Functional safety information”. That is, each segment is associated with a message type whose existence is allowed. A plurality of segments may be associated with the same message type.

As shown in FIG. 1, vehicle access control system 1 is provided in DC 100, 110 inside a vehicle and includes first access controller 51, second access controller 52, and third access controller 53. In the embodiment, first access controller 51, second access controller 52, and third access controller 53 each correspond to one of a plurality of filters 50. Note that vehicle access control system 1 only needs to include these controllers. The configuration of DC 100, 110 on the vehicle other than these controllers are not necessarily the elements of vehicle access control system 1.

In the example shown in FIG. 1, filter 50 named “Filter 1-B” corresponds to first access controller 51, filter 50 named “Filter 2-A”, corresponds to second access controller 52, and filter 50 named “Filter 1-A”, corresponds to third access controller 53.

That is, each filter 50 has the function of one of first access controller 51, second access controller 52, and third access controller 53. Which of the functions of first access controller 51, second access controller 52, and third access controller 53 is to be fulfilled is determined based on the conditions of the communication.

DC 100 is a computer including a processor (i.e., a microprocessor), a memory, and other suitable elements. The memory is a read only memory (ROM) or a random access memory (RAM), for example, and can store programs to be executed by the processor.

DC 100 includes a system-on-a-chip (SoC) 10 and MCU 20 as hardware. The hardware is a machine or device capable of receiving data, performing logical operations on data, storing data in the memory, and display data on the display, for example. The hardware may include a processor and a memory. The hardware includes a communication interface for communicating with other hardware in the vehicle through the Ethernet, the CAN, the serial communication, or the serial peripheral interface (SPI), for example.

In the embodiment, SoC 10 includes Ethernet communicator 10A that is a communication interface for the Ethernet communication with an external device (e.g., DC 110 here). On the other hand, MCU 20 includes CAN communicator 20A that is a communication interface for the CAN communication with an external device (e.g., DC 110 here). SoC 10 and MCU 20 can communicate with each other via serial communicator 40A that is a communication interface for the serial communication.

In SoC 10, virtualization platform 30 operates. Virtualization platform 30 is a hypervisor, for example, and software that serves as a virtualization platform for operating one or more virtual machines. On virtualization platform 30, one or more virtual machines (e.g., three virtual machines here) separated from each other are operating. In the embodiment, a virtual machine in “Area 1-A”, a virtual machine in “Area 1-B”, and a virtual machine in “Area 1-C” are operating on virtualization platform 30. “Area 1-A” is an external connection area, for example. “Area 1-C” is a safety area, for example. “Area 1-B” is an intermediate area in communication between the external connection area and the safety area, for example.

The external connection area includes an entry point (EP), a communication function with the outside, or a transport level security (TLS) termination, for example, and has an external connection function that can serve as an entry point for an attacker. The safety area includes functions related to the vehicle safety (i.e., functions such as running, turning, or stopping), for example.

Virtualization platform 30 includes inter-VM communicator 30A. Inter-VM communicator 30A controls a communication from any one of one or more virtual machines as a source, and a communication to any one of one or more virtual machines as a destination. That is, communications with one or more virtual machines in SoC 10 are only possible via inter-VM communicator 30A.

In MCU 20, the virtual machine in “Area 1-D” is operating which is achieved by a hardware virtualization support mechanism. “Area 1-D” is a safety area, for example. Communications with a virtual machine (e.g., a virtual machine in “Area 1-D” here) in MCU are only possible via CAN communicator 20A or serial communicator 40A. Note that “Area 1-D” may be a process achieved by an OS.

A messages is transmitted and received via Ethernet communicator 10A, CAN communicator 20A, inter-VM communicator 30A, and serial communicator 40A. Access control for message transmission and reception at each communicator 10A, 20A, 30A, or 40A is achieved by a plurality of filters 50. Each filter 50 may be provided in each communicator 10A, 20A, 30A, or 40A or may be provided as software on SoC 10 or MCU 20 in which communicator 10A, 20A, 30A, or 40A is installed.

In the embodiment, vehicle access control system 1 includes “Filter 1-A”, “Filter 1-B”, “Filter 1-C”, and “Filter 1-D” corresponding to “Area 1-A”, “Area 1-B”, “Area 1-C”, and “Area 1-D”, respectively.

DC 110 includes SoC 11 and MCU 21 as hardware. In the embodiment, SoC 11 includes Ethernet communicator 11A that is a communication interface for the Ethernet communication with an external device (e.g., DC 100 here). On the other hand, MCU 21 includes CAN communicator 21A that is a communication interface for the CAN communication with an external device (e.g., DC 100 here). SoC 11 and MCU 21 can communicate with each other via serial communicator 41A that is a communication interface for the serial communication.

In SoC 11, virtualization platform 31 is operating. On virtualization platform 31, one or more virtual machines (e.g., three virtual machines here) separated from each other are operating. In the embodiment, a virtual machine in “Area 2-A”, a virtual machine in “Area 2-B”, and a virtual machine in “Area 2-C” are operating on virtualization platform 31. “Area 2-A” is an external connection area, for example. “Area 2-C” is a safety area, for example. “Area 2-B” is an intermediate area, for example.

Virtualization platform 31 includes inter-VM communicator 31A. Communications with one or more virtual machines in SoC 11 are only possible via inter-VM communicator 31A.

In MCU 21, a virtual machine in “Area 2-D” is operating which is achieved by a hardware virtualization support mechanism. “Area 2-D” is a safety area, for example. Communications with a virtual machine (e.g., a virtual machine in “Area 2-D” here) in MCU 21 are only possible via CAN communicator 21A or serial communicator 41A. Note that “Area 2-D” may be a process achieved by an OS.

A messages is transmitted and received via Ethernet communicator 11A, CAN communicator 21A, inter-VM communicator 31A, and serial communicator 41A. Access control for message transmission and reception at each communicator 11A, 21A, 31A, or 41A is implemented by a plurality of filters 50. Each filter 50 may be provided in communicator 11A, 21A, 31A, or 41A or may be provided as software on SoC 11 or MCU 21 in which each communicator 11A, 21A, 31A, or 41A is installed.

In the embodiment, vehicle access control system 1 includes “Filter 2-A”, “Filter 2-B”, “Filter 2-C”, and “Filter 2-D” corresponding to “Area 2-A”, “Area 2-B”, “Area 2-C”, and “Area 2-D”, respectively.

Each filter 50 has a policy including a rule related to a received message. In the embodiment, the policy defines, for each data type, the area of the destination, the area of the source, and the area of the intermediate destination on the way to the area of the destination. Note that the policy may exclude the intermediate destination depending on the data type and filter 50. Each filter 50 then executes determination processing to determine whether to transmit the received message, based on the policy. For example, each filter 50 transmits the message to the intermediate destination, if the policy includes the data type, the destination, the source, and the intermediate destination of the received message. Note that each filter 50 transmits the message to the destination, if the received message includes no intermediate destination. On the other hand, each filter 50 discards the message, if the policy lacks at least one of the data type, the destination, the source, or the intermediate destination of the received message.

As described already, in the embodiment, first access controller 51, second access controller 52, and third access controller 53 each correspond to one of a plurality of filters 50. Now, first access controller 51, second access controller 52, and third access controller 53 will be described.

First access controller 51 controls communication in a first area of a segment including a plurality of areas. In the example shown in FIG. 1, “Filter 1-B” serves as first access controller 51, the segment includes “Area 1-B” of DC 100 and “Area 2-A” of DC 110. “Filter 1-B” controls a communication in the first area (i.e., “Area 1-B”) of the segment.

Specifically, when receiving a message from an application of the first area, for example, first access controller 51 executes determination processing to determine whether to transmit the received message, based on the own policy. First access controller 51 then transmits the message to the destination or the intermediate destination or discards the message in accordance with the result of determination processing. If the destination of the message is in the own area, first access controller 51 transmits the message to the application of this area.

Second access controller 52 controls communication in a second area of the segment. In the example shown in FIG. 1, “Filter 2-A” is second access controller 52. “Filter 2-A” controls a communication in the second area (i.e., “Area 2-A”) of the segment.

Specifically, when receiving a message, second access controller 52 executes determination processing to determine whether to transmit the received message, based on the own policy. Second access controller 52 then transmits the message to the destination or the intermediate destination or discards the message in accordance with the result of determination processing. If the destination of the message is in the own area, second access controller 52 transmits the message to the application of this area.

Third access controller 53 controls communication in a third area different from the first area and the second area. In addition, third access controller 53 has a function to convert a communication protocol. In the example shown in FIG. 1, “Filter 1-A” is third access controller 53. “Filter 1-A” controls a communication in the third area (i.e., “Area 1-A”) which is an area outside the segment to which the first area (i.e., “Area 1-B”) and the second area (i.e., “Area 2-A”) belong. “Filter 1-A” has the function to convert the communication protocol using inter-VM communicator 30A and the communication protocol using Ethernet communicator 11A.

Specifically, when receiving a message, third access controller 53 executes determination processing to determine whether to transmit the received message, based on the own policy. Third access controller 53 then transmits the message to the destination or the intermediate destination or discards the message in accordance with the result of determination processing. If the destination of the message is in the own area, third access controller 53 transmits the message to the application of this area.

Here, first access controller 51 causes the third area to relay a message transmitted from the first area to the second area. In the example shown in FIG. 1, first access controller 51 needs to allow a communication via “Ethernet communicator 10A”, when a message is transmitted from the first area (i.e., “Area 1-B”) to the second area (i.e., “Area 2-A”). First access controller 51 has no function for communications via Ethernet communicator 10A. That is, in the example shown in FIG. 1, the first area (i.e., “Area 1-B”) and the second area (i.e., “Area 2-A”) cannot directly communicate with each other.

In the case described above, first access controller 51 causes the third area (i.e., “Area 1-A”) to relay the message. That is, “Filter 1-A” serving as third access controller 53 of the third area (i.e., “Area 1-A”) has a function to convert the communication protocol using inter-VM communicator 30A and the communication protocol using Ethernet communicator 11A. First access controller 51 can thus transmit a message to the second area (i.e., “Area 2-A”) via the third area (i.e., “Area 1-A”).

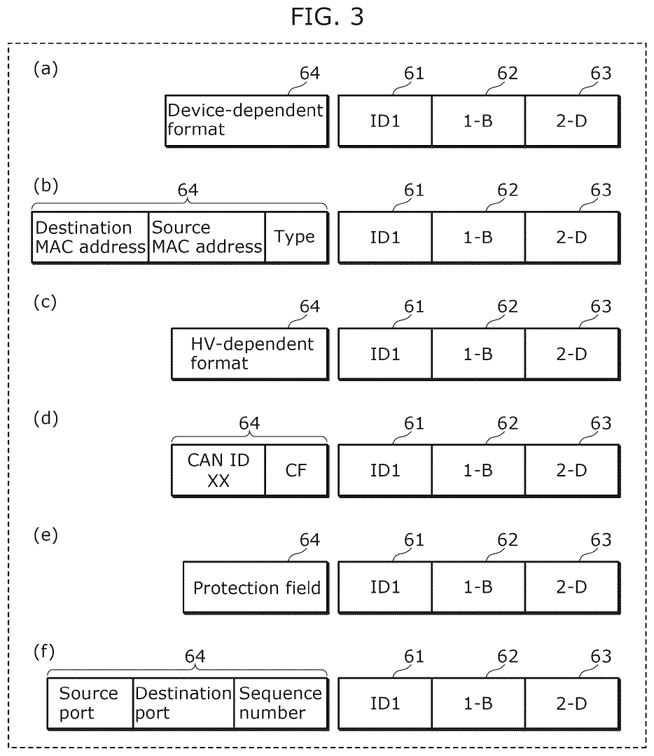

Now, an example will be described where third access controller 53 converts the communication protocol of the message received from first access controller 51 and transmits the message to another area. Third access controller 53 adds, to the received message, communication data 64 (see FIG. 3) used for a communication with the destination of the message, and transmits the message.

FIG. 3 shows example communication data. FIG. 3 shows data included in a message. The message includes identifier 61 showing the data type, source 62, address 63, and communication data 64. Identifier 61, source 62, and address 63 are data to be referred to as the determination processing by each filter 50 and common data independent from the communication protocol. On the other hand, communication data 64 is unique to the communication protocol. Note that the common data may include an intermediate destination.

In FIG. 3, (a) shows the case where a device-dependent format for use in the SPI communication, that is, the serial communication, is added as communication data 64. In FIG. 3, (b) shows the case where the destination media access control (MAC) address, the source MAC address, and the type for use in the Ethernet communication are added as communication data 64. In FIG. 3, (c) shows the case where a hypervisor (HV)-dependent format for use in the inter-VM communication is added as communication data 64. In FIG. 3, (d) shows the case where the CAN ID and the control field (CF) for use in the CAN communication are added as communication data 64. In FIG. 3, (e) shows the case where the protection field including the ID, the size, and other information for use in the local interconnect network (LIN) communication is added as communication data 64. In FIG. 3, (f) shows the case where the source port, the address port, the sequence number, or other information for use in the socket communication under the transmission control protocol (TCP), the user datagram protocol (UDP), the internet protocol (IP), or any other suitable protocol are added as communication data 64.

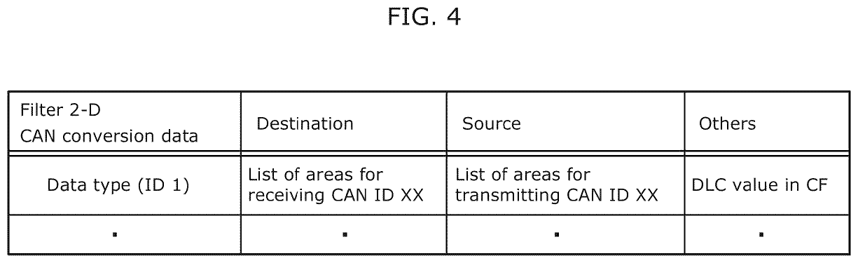

FIG. 4 shows example conversion data. The conversion data is for converting communication data 64 included in the received message to common data in the determination processing. The example in FIG. 4 shows example conversion data of “Filter 2-D” capable of the CAN communication. When receiving a message with CAN ID “XX”, for example, “Filter 2-D” reads the CAN ID “XX” as common data (e.g., the destination and the source here), referring to the conversion data.

### 2. Communication Examples of Vehicle Access Control System

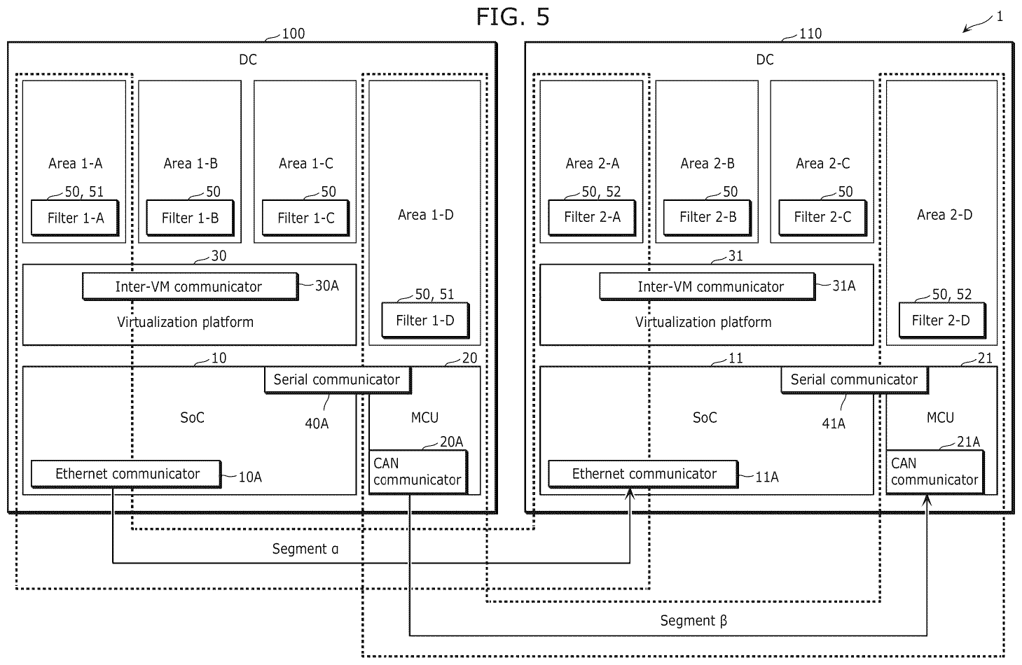

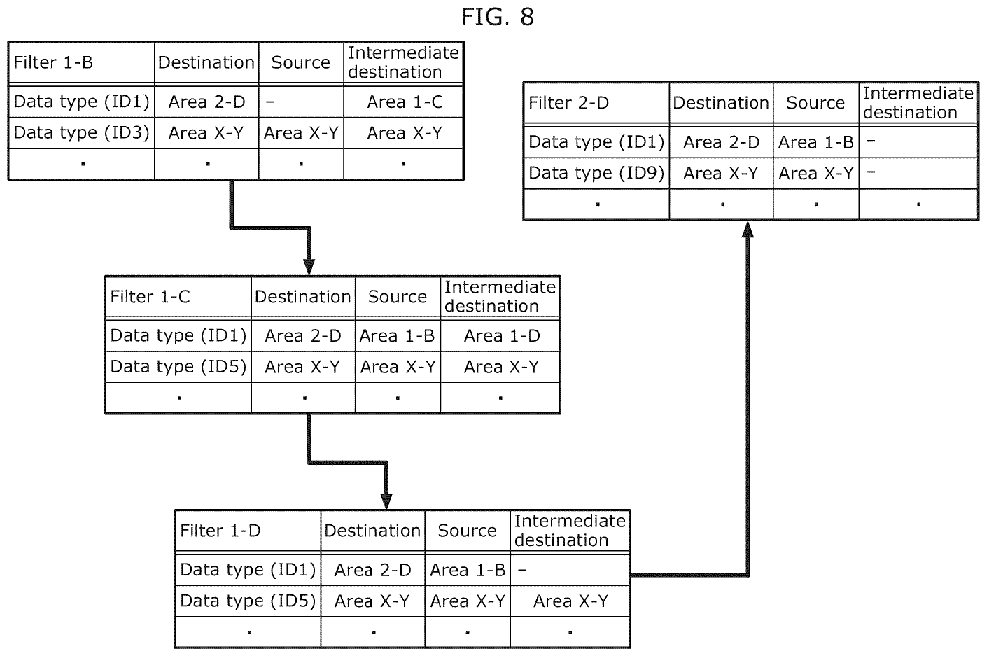

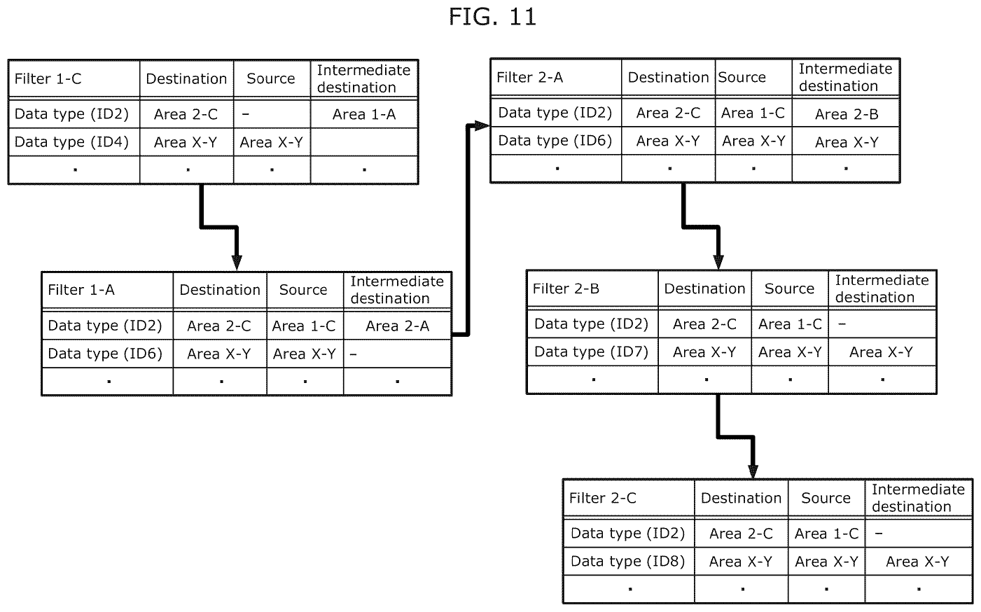

Now, communication examples of vehicle access control system 1 according to the embodiment will be raised. In the following, in the block diagrams (FIGS. 5, 6, and 9) of the communication examples, a plurality of areas belonging to the same segment are surrounded by dotted lines and the paths of transmitting a message are represented by arrows. In the figures (FIGS. 8 and 11) showing the example policies of the communication examples, “Area X-Y” is defined for each policy but not mentioned particularly.

### 2-1. First Communication Example

FIG. 5 is a block diagram showing a first communication example of vehicle access control system 1 according to the embodiment. In the first communication example, the first area and the second area can directly communicate with each other. Specifically, assume that a message is transmitted from “Area 1-A” of DC 100 to “Area 2-A” of DC 110 belonging to the same “Segment a”. In this case, “Filter 1-A” corresponding to “Area 1-A” and “Filter 2-A” corresponding to “Area 2-A” can directly communicate with each other through the Ethernet communication.

When receiving the message from an application of “Area 1-A”, “Filter 1-A” executes determination processing. If the policy includes the data type, the destination (i.e., “Area 2-A” here), and the source (i.e., “Area 1-A” here) of the received message, “Filter 1-A” transmits the message to the destination via Ethernet communicators 10A and 11A. When receiving the message, “Filter 2-A” executes determination processing. If the policy includes the data type, the destination (i.e., “Area 2-A” here), and the source (i.e., “Area 1-A” here) of the received message, “Filter 2-A” transmits the message to an application of “Area 2-A”. In this case, “Filter 1-A” functions as first access controller 51, and “Filter 2-A” functions as second access controller 52.

Similarly, assume that a message is transmitted from “Area 1-D” of DC 100 to “Area 2-D” of DC 110 belonging to the same “Segment β”. In this case, “Filter 1-D” corresponding to “Area 1-D” and “Filter 2-D” corresponding to “Area 2-D” can directly communicate with each other through the CAN communication.

When receiving a message from an application of “Area 1-D”, “Filter 1-D” executes determination processing. If the policy includes the data type, the destination (i.e., “Area 2-D” here), and the source (i.e., “Area 1-D” here) of the received message, “Filter 1-D” transmits the message to the destination via CAN communicators 20A and 21A. When receiving a message, “Filter 2-D” executes determination processing. If the policy includes the data type, the destination (i.e., “Area 2-D” here), and the source (i.e., “Area 1-D” here) of the received message, “Filter 2-D” transmits the message to an application of “Area 2-D”. In this case, “Filter 1-D” functions as first access controller 51, and “Filter 2-D” functions as second access controller 52.

### 2-2. Second Communication Example

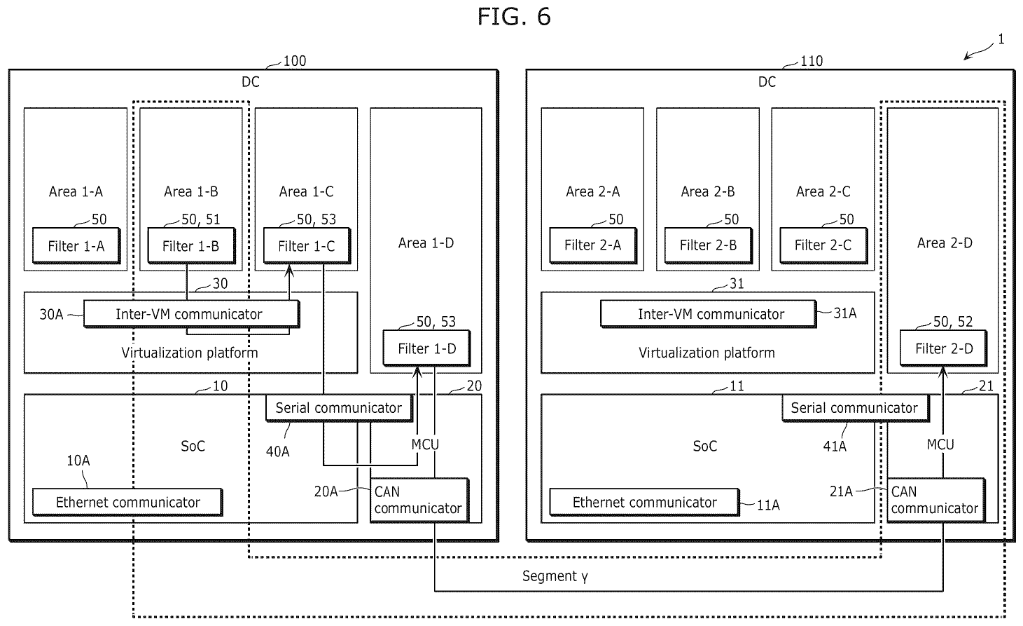

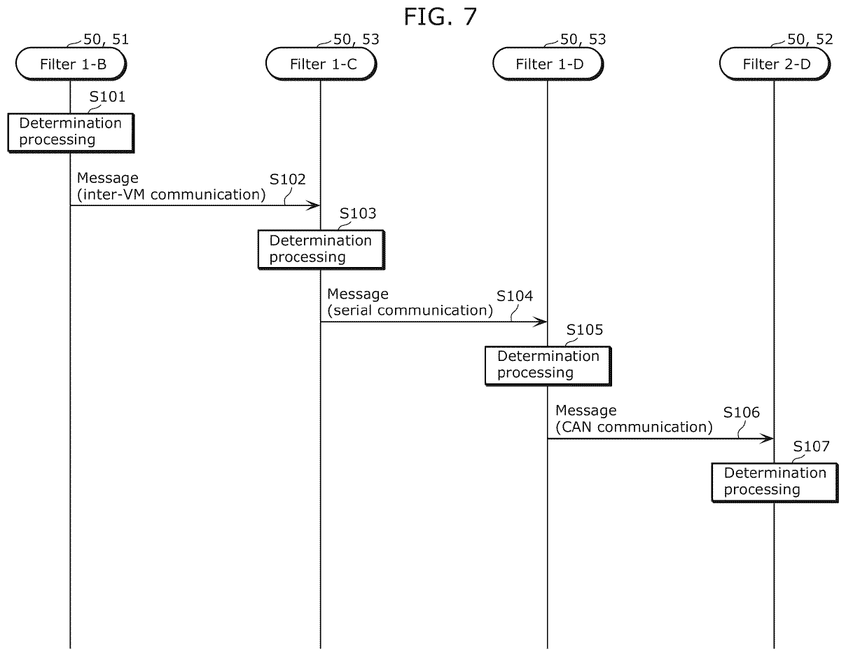

FIG. 6 is a block diagram showing a second communication example of vehicle access control system 1 according to the embodiment. FIG. 7 is a sequence diagram showing the second communication example of vehicle access control system 1 according to the embodiment. FIG. 8 shows an example policy for use in the second communication example of vehicle access control system 1 according to the embodiment.

In the second communication example, the first area and the second area cannot directly communicate with each other. Specifically, assume that a message is transmitted from “Area 1-B” of DC 100 to “Area 2-D” of DC 110 belonging to the same “Segment γ”. In this case, “Filter 1-B” corresponding to “Area 1-B” and “Filter 2-D” corresponding to “Area 2-D” cannot directly communicate with each other by the CAN communication.

To address the problem, in the second communication example, “Filter 1-B” corresponding to the first area “Area 1-B” transmits a message via “Filter 1-C” corresponding to the third area “Area 1-C”, and “Filter 1-D” corresponding to the third area “Area 1-D” to “Filter 2-D” corresponding to the second area “Area 2-D”. That is, in the second communication example, “Filter 1-B” functions as first access controller 51, “Filter 2-D” functions as second access controller 52, and “Filter 1-C” and “Filter 1-D” each function as third access controller 53.

Now, specific embodiments of communication will be described with reference to FIGS. 7 and 8. First, when receiving a message of the data type “ID1” from the application of “Area 1-B”, “Filter 1-B” executes determination processing to determine whether the own policy includes the data type, the destination, the source, and the intermediate destination of the message (S101). If the policy is determined to include such information, “Filter 1-B” transmits the message to “Filter 1-C” that is the intermediate destination “Area 1-C” through the inter-VM communication (S102).

When receiving the message from “Filter 1-B”, “Filter 1-C” executes determination processing to determine whether the own policy includes the data type, the destination, the source, and the intermediate destination of the message (S103). If the policy is determined to include such information, “Filter 1-C” transmits the message to “Filter 1-D” that is the intermediate destination “Area 1-D” through the serial communication (S104).

When receiving the message from “Filter 1-C”, “Filter 1-D” executes determination processing to determine whether the own policy includes the data type, the destination, the source, and the intermediate destination of the message (S105). If the policy is determined to include such information, “Filter 1-C” transmits the message to “Filter 2-D” that is the destination “Area 2-D” through the CAN communication (S106).

When receiving the message from “Filter 1-D”, “Filter 2-D” executes determination processing to determine whether the own policy includes the data type, the destination, the source, and the intermediate destination of the message (S107). Since the address of the message matches the address in the policy, “Filter 2-D” transmits a message to the application of the corresponding “Area 2-D”. In this manner, communications between “Area 1-B” and “Area 2-D” that cannot directly communicate with each other becomes possible via “Area 1-C” and “Area 1-D”.

### 2-3. Third Communication Example

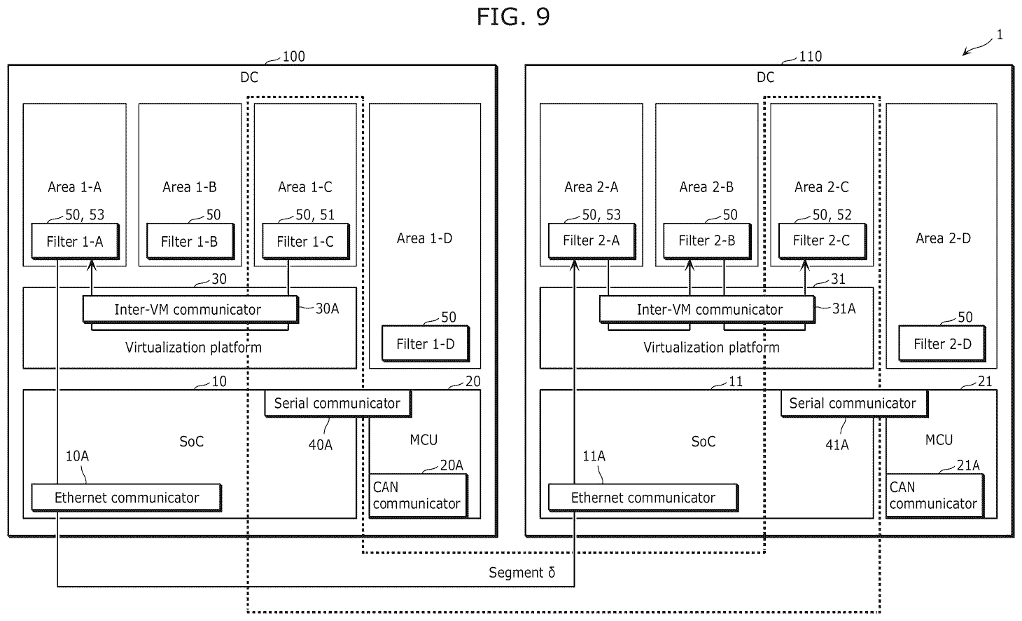

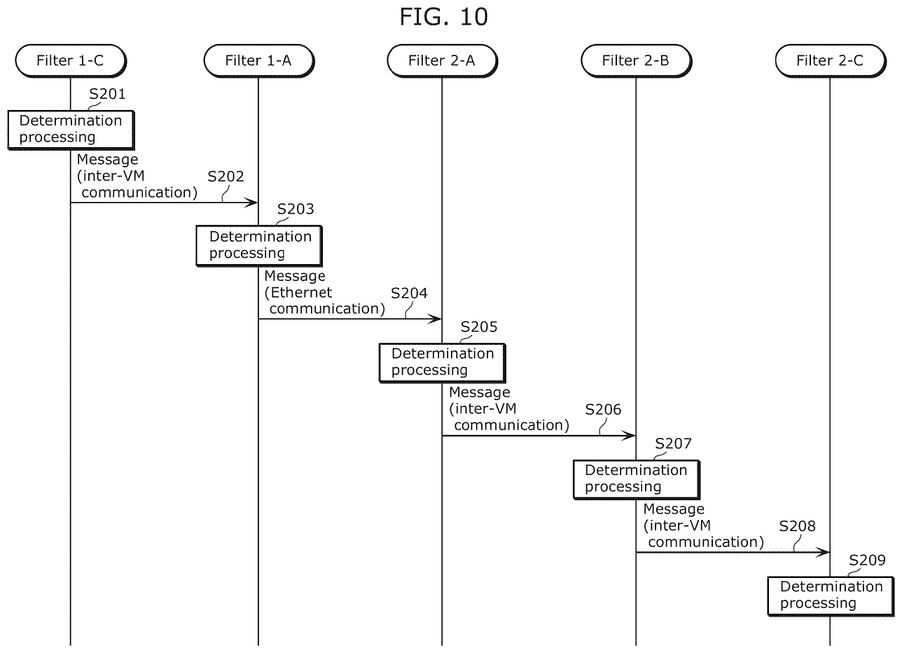

FIG. 9 is a block diagram showing a third communication example of vehicle access control system 1 according to the embodiment. FIG. 10 is a sequence diagram showing the third communication example of vehicle access control system 1 according to the embodiment. FIG. 11 shows an example policy for use in the third communication example of vehicle access control system 1 according to the embodiment.

As in the second communication example, in the third communication example, the first area and the second area cannot directly communicate with each other. Specifically, assume that a message is transmitted from “Area 1-C” of DC 100 to “Area 2-C” of DC 110 belonging to the same “Segment o”. In this case, “Filter 1-C” corresponding to “Area 1-C” and “Filter 2-C” corresponding to “Area 2-C” cannot directly communicate with each other through the Ethernet communication.

In the third communication example, “Filter 1-C” corresponding to the first area “Area 1-C” transmits a message via “Filter 1-A” corresponding to the third area “Area 1-A” and “Filter 2-A” corresponding to the third area “Area 2-A” to “Filter 2-C” corresponding to the second area “Area 2-C”. In the third communication example, “Filter 1-C” functions as first access controller 51, “Filter 2-C” functions as second access controller 52, and “Filter 1-A” and “Filter 2-A” each serve as third access controller 53. In the third communication example, “Filter 2-B” corresponding to “Area 2-B” relays the message but does not convert the communication protocol, and thus does not correspond to third access controller 53.

Now, specific embodiments of communication will be described with reference to FIGS. 10 and 11. First, when receiving a message of the data type “ID2” from the application of “Area 1-C”, “Filter 1-C” executes determination processing to determine whether the own policy includes the data type, the destination, the source, and the intermediate destination of the message (S201). If the policy is determined to include such information, “Filter 1-C” transmits a message to “Filter 1-A” of the intermediate destination “Area 1-A” through the inter-VM communication (S202).

When receiving the message from “Filter 1-C”, “Filter 1-A” executes determination processing to determine whether the own policy includes the data type, the destination, the source, and the intermediate destination of the message (S203). If the policy is determined to include such information, “Filter 1-A” transmits the message to “Filter 2-A” of the intermediate destination “Area 2-A” through the Ethernet communication (S204).

When receiving the message from “Filter 1-A”, “Filter 2-A” executes determination processing to determine whether the own policy includes the data type, the destination, the source, and the intermediate destination of the message (S205). If the policy is determined to include such information, “Filter 2-A” transmits the message to “Filter 2-B” of the intermediate destination “Area 2-B” through the inter-VM communication (S206).

When receiving the message from “Filter 2-A”, “Filter 2-B” executes determination processing to determine whether the own policy includes the data type, the destination, the source, and the intermediate destination of the message (S207). If the policy is determined to include such information, “Filter 2-B” transmits the message to the “Filter 2-C” of the destination “Area 2-C” through the inter-VM communication (S208).

When receiving the message from “Filter 2-B”, “Filter 2-C” executes determination processing to determine whether the own policy includes the data type, the destination, the source, and the intermediate destination of the message (S209). Since the destination of the message matches the destination in the policy, “Filter 2-C” transmits the message to the application of the corresponding “Area 2-C”. In this manner, communications between “Area 1-C” and “Area 2-C” that cannot directly communicate with each other becomes possible via “Area 1-A”, “Area 2-A”, and “Area 2-B”.

In the third communication example, the security is improved by causing “Area 2-B”, which functions as a gateway, to relay a message transmitted from “Area 2-A” to “Area 2-C”. The configuration is not limited thereto. For example, in the third communication example, a message may be transmitted from “Area 2-A” to “Area 2-C” not via “Area 2-B”.

### 3. Advantages

Now, the advantages of vehicle access control system 1 according to the embodiment will be described. As described above, vehicle access control system 1 according to the embodiment allows communications between the first area and the second area via the third area with the function to convert the communication protocol, even when a message is transmitted from the first area to the second area and the first area and the second area cannot directly communicate with each other. On the other hand, vehicle access control system 1 according to the embodiment can improve the security in the communications between the first area and the second area via the third area, even when the first area and the second area can directly communicate with each other. Accordingly, vehicle access control I system 1 according to the embodiment is advantageous in applying segment separation to an on-vehicle system assuming the employment of a plurality of communication protocols and easily achieving the segment separation at relatively low costs.

### Other Embodiments

The embodiment has been described above as an example of the technique related to the present disclosure. The technique related to the present disclosure is however not limited thereto. Embodiments obtained by modifications, replacements, additions, and omission are applicable as appropriate. For example, an embodiment of the present disclosure includes the following variations.

For example, in the embodiment described above, each of first access controller 51, second access controller 52, and third access controller 53 may encrypt a message and transmit the encrypted message from the own segment to another segment. For example, when a message is transmitted from the first area to the second area via the third area outside the segment, the data of the type allowed to exist only in the segment may leak outside the segment. The leakage can be reduced by encrypting the message. Instead of encrypting the message, the data may be deleted from the memory after transmitting or receiving the message in filter 50 corresponding to the third area.

In the embodiment described above, if any filter 50 or the policy of any filter 50 is falsified, data may leak outside the segment. To reduce the leakage of the data, a digital signature may be given to this filter 50 and the policy of this filter 50 for each filter 50, and verified at the time of starting the device (e.g., the DC) or at the time of communication to ensure the completeness of this filter 50 and the policy of this filter 50.

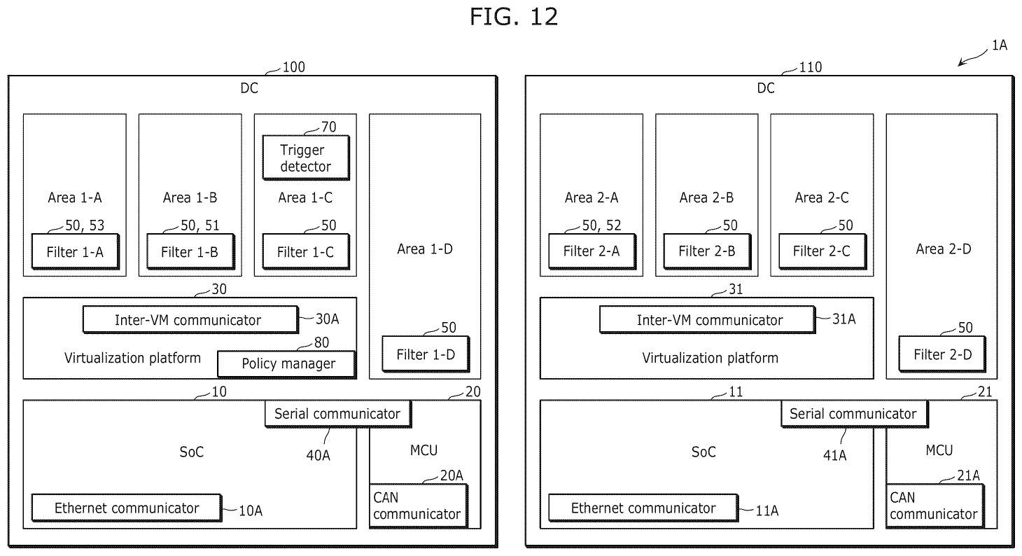

For example, only when certain conditions are met, part of the own policy of each filter 50 may be changed temporarily or replaced with another policy. Now, such a configuration will be described with reference to FIG. 12.

FIG. 12 is a block diagram showing an example functional configuration of vehicle access control system 1A according to a variation of the embodiment. Vehicle access control system 1A according to this variation is different from vehicle access control system 1 according to the embodiment in further including trigger detector 70 and policy manager 80.

Trigger detector 70 is included in an area other than the external connection area, for example, and detects a trigger related to the vehicle. Trigger detector 70 is included in an area according to the trigger types raised below. In the example shown in FIG. 12, trigger detector 70 is included in “Area 1-C” that is a safety area.

Trigger detector 70 detects a trigger according to the state of the vehicle, for example. Examples of the state of the vehicle may include “traveling”, “stopped”, “located at a certain point of a residence, workplace, or store”, “being charged” if the vehicle is an electric vehicle, “ready to communicate” or “not ready to communicate”, and “manual driving” or “autonomous driving”. As an example, while the vehicle is being charged, the external connection area needs to be temporarily included in the segment including the safety area in order to notify an information processing terminal, such as a smartphone, of the user of the charging status of the vehicle. In such a case, trigger detector 70 detects a trigger according to the state in which the vehicle is being charged.

Trigger detector 70 detects a trigger according to the contract conditions or usage conditions of connected service for use in the vehicle, for example. As an example, the external connection area needs to be temporarily included in the segment including the safety area in order to obtain, from the outside of the vehicle, information as to whether there is a contract for connected service or information required in the use of the service. In such a case, trigger detector 70 detects a trigger according to the contract status or usage status of the connected service.

Trigger detector 70 detects a trigger according to the occupant of the vehicle. As an example, accessible information may be limited for each passenger of the vehicle. In this case, trigger detector 70 detects a trigger according to the identification information of the occupant. Examples of the identification information may include the key of the vehicle and biometric information, such as the face or fingerprint of the occupant.

Trigger detector 70 detects a trigger according to a vehicle anomaly, such as an external access attack, or a vehicle malfunction. As an example, if a vehicle is attacked by external access, separating the attacked area from the segment is necessary. In such a case, trigger detector 70 detects a trigger according to the external access attack.

Policy manager 80 may be included at a lower stage than a virtual machine, for example, and manages the policy of each filter 50, that is, each of first access controller 51, second access controller 52, and third access controller 53. In the example shown in FIG. 12, policy manager 80 is included on virtualization platform of DC 100.

Policy manager 80 changes the policy when trigger detector 70 detects a trigger. Here, changing the policy may include changing part of the policy of each filter 50 (i.e., the policy of each of first access controller 51, second access controller 52, and third access controller 53) and changing the policy of each filter 50 to another policy prepared in advance. The policy change may continue temporarily or permanently.

For example, if trigger detector 70 detects a trigger according to an external access attack, policy manager 80 changes the policy of each filter 50 to separate the attacked area from the segment. In this manner, vehicle access control system 1A according to this variation is advantageous in dynamically changing the policy in accordance with the vehicle conditions.

For example, in the embodiment described above, DC 100, 110 includes four virtual machines, but may include three or less virtual machines or five or more virtual machines. In the embodiment described above, the segments are configured on a virtual-machine-by-virtual-machine basis but may be configured on a container-by-container basis or may include both virtual machines and containers. Alternatively, the segments may be on an application-by-application basis or a process-by-process basis. In this case, each filter 50 may be located in a communicator for communications between applications or between processes.

For example, in the embodiment described above, each filter 50 employs a rule independent from the communication protocol, and dynamically converts the rule into a rule dependent on the communication protocol, using the conversion data shown in FIG. 4. Each filter 50 may however employ a rule dependent on the communication protocol.

Specifically, the data type of the common data of a message may include data unique to a communication protocol. Examples includes the following. If the communication protocol is the CAN, the CAN IDs are the data type of the common data. If the communication protocol is the Ethernet, the destination MAC address, and the source MAC address are the data type of the common data. If the communication protocol is socket, the destination port and the source port are the data type of the common data. In these cases, third access controller 53 does not necessarily add communication data 64 to the message.

For example, in the embodiment described above, assume that each of SoC 10 and MCU 20 includes a plurality of CPU cores. If hardware or software that controls communications between the CPU cores are provided, inter-CPU-core communications may be employed in place of inter-virtual-machine communications. In this case, each of SoC 10 and MCU 20 requires neither virtualization platform 30 nor hardware virtualization support mechanism.

For example, an example has been described above in the embodiment where vehicle access control system 1 is configured by DCs 100 and 110. The configuration is not limited thereto. Vehicle access control system 1 may be achieved by high-performance computing (HPC).

The order of executing the steps in the sequence diagrams is a mere example for specifically describing the present disclosure and may be different. Part of the steps may be executed at the same time (i.e., in parallel) with another step or part of the steps are not necessarily executed.

How to divide the functional blocks in the block diagrams is an example. A plurality of functional blocks may serve as one functional block, one functional block may be divided into a plurality of parts, some functions may be transferred to another functional block. The functions of a plurality of functional blocks having similar functions may be processed by one hardware or software in parallel or in a time-division manner.

The elements described above in the embodiment, for example, may serve as software or may typically serve as LSI circuits which are integrated circuits. These may be each one individual chip or some or all may be included in one chip. While the LSI circuit is named here, the integrated circuit may be referred to an IC, a system LSI circuit, a super LSI circuit, or an ultra-LSI circuit in accordance with the degree of integration. The circuit integration is not limited to the LSI. The devices may be dedicated circuits (or general-purpose circuits for executing dedicated programs) or general-purpose processors. A field programmable gate array (FPGA) programmable after the manufacture of an LSI circuit or a reconfigurable processor capable of reconfiguring the connections and settings of circuit cells inside an LSI may be employed. Appearing as an alternative circuit integration technique to the LSI, another technique that progresses or deprives from the semiconductor technique may be used for integration of elements.

The system LSI circuit is a super multifunctional LSI circuit manufactured by integrating a plurality of processors on one chip, and specifically is a computer system including a microprocessor, a read-only memory (ROM), and a random-access memory (RAM), for example. The ROM stores computer programs. The microprocessor operates in accordance with the computer programs so that the system LSI circuit fulfills its functions.

An aspect of the present disclosure may be directed to a computer program for causing a computer to execute the characteristic steps included in the security measure shown in any of the first to third communication examples described above.

For example, the program may be to be executed by a computer. An aspect of the present disclosure may be directed to a non-transitory computer-readable recording medium having such a program recorded thereon. For example, such a program may be recorded in a recording medium and distributed. For example, the distributed program is installed in a device including another processor and executed by the processor so that the device can perform the processing.

The present disclosure may include forms obtained by various modifications to the foregoing embodiments that can be conceived by those skilled in the art or forms achieved by freely combining the elements and functions in the foregoing embodiments without departing from the scope and spirit of the present disclosure.

### SUMMARY

As described above, vehicle access control system 1, 1A according to a first aspect is provided in a vehicle. Vehicle access control system 1, 1A includes first access controller 51, second access controller 52, and third access controller 53. First access controller 51 controls communication in a first area of a segment including a plurality of areas. Second access controller 52 controls communication in a second area of the segment. Third access controller 53 controls communication in a third area different from the first area and the second area and has a function to convert a communication protocol. First access controller 51 causes the third area to relay a message transmitted from the first area to the second area.

This configuration allows communications between the first area and the second area via the third area with the function to convert the communication protocol, even when a message is transmitted from the first area to the second area and the first area and the second area cannot directly communicate with each other. On the other hand, this configuration can improve the security in the communications between the first area and the second area via the third area, even when the first area and the second area can directly communicate with each other. This is thus advantageous in applying segment separation to an on-vehicle system assuming the employment of a plurality of communication protocols and easily achieving the segment separation at relatively low costs.

Vehicle access control system 1, 1A according to a second aspect is an embodiment of the first aspect. Each of first access controller 51, second access controller 52, and third access controller 53 has a policy including a rule related to the message received, and determines whether to transmit the message received, based on the policy.

This configuration can transmit only the allowed messages and is advantageous in easily ensuring the security inside the vehicle.

Vehicle access control system 1, 1A according to a third aspect is an embodiment of the second aspect. Third access controller 53 adds, to the message, communication data 64 for use in communication with the destination of the message, and transmits the message.

This is advantageous in establishing a communication according to various communication protocols by adding communication data 64 according to communication protocol to the message.

Vehicle access control system 1, 1A according to a fourth aspect is an embodiment of the second or third aspect. Each of first access controller 51, second access controller 52, and third access controller 53 encrypts a message to be transmitted from the segment to which the access controller belongs, to another segment.

According to this, when a message is transmitted from the first area to the second area via the third area outside the segment, the data of the type whose existence is allowed only in the segment may leak outside the segment. The configuration described above is advantageous in easily reducing the leakage by encrypting the message in this manner.

Vehicle access control system 1A according to a fifth aspect is an embodiment of one of the second to fourth aspects. Vehicle access control system 1A further includes trigger detector 70 and policy manager 80. Trigger detector 70 detects a trigger related to the vehicle. Policy manager 80 manages the policy of each of first access controller 51, second access controller 52, and third access controller 53. Policy manager 80 changes the policy, when trigger detector 70 detects the trigger.

This is advantageous in dynamically changing the policy in accordance with the vehicle conditions.

An access control method according to a sixth aspect is to be executed by vehicle access control system 1, 1A provided in a vehicle. Vehicle access control system 1, 1A controls communication in a first area of a segment including a plurality of areas. Vehicle access control system 1, 1A controls communication in a second area of the segment. Vehicle access control system 1, 1A has a function to convert a communication protocol and controls communication in a third area different from the first area and the second area. Vehicle access control system 1, 1A causes the third area to relay a message transmitted from the first area to the second area.

This method allows communications between the first area and the second area via the third area with the function to convert the communication protocol, even when a message is transmitted from the first area to the second area and the first area and the second area cannot directly communicate with each other. On the other hand, this method can improve the security in the communications between the first area and the second area via the third area, even when the first area and the second area can directly communicate with each other. This is thus advantageous in applying segment separation to an on-vehicle system assuming the employment of a plurality of communication protocols and easily achieving the segment separation at relatively low costs.

A program according to a seventh aspect is for causing one or more processors to execute the access control method according to the sixth aspect.

This program allows communications between the first area and the second area via the third area with the function to convert the communication protocol, even when a message is transmitted from the first area to the second area and the first area and the second area cannot directly communicate with each other. On the other hand, this program can improve the security in the communications between the first area and the second area via the third area, even when the first area and the second area can directly communicate with each other. This is thus advantageous in applying segment separation to an on-vehicle system assuming the employment of a plurality of communication protocols and easily achieving the segment separation at relatively low costs.

### FURTHER INFORMATION ABOUT TECHNICAL BACKGROUND TO THIS APPLICATION

The disclosures of the following patent applications including specification, drawings, and claims are incorporated herein by reference in their entirety: Japanese Patent Application No. 2024-011923 filed on Jan. 30, 2024, and Japanese Patent Application No. 2024-059917 filed on Apr. 3, 2024.

### INDUSTRIAL APPLICABILITY

The present disclosure is applicable to an on-vehicle network.

1. A vehicle access control system provided in a vehicle, the vehicle access control system comprising:
memory storing a program; and
processor, wherein
by executing the program, the processor is configured to operate as:
a first access controller that controls communication in a first area of a segment including a plurality of areas;
a second access controller that controls communication in a second area of the segment; and
a third access controller that controls communication in a third area different from the first area and the second area and has a function to convert a communication protocol; wherein
the first access controller causes the third area to relay a message transmitted from the first area to the second area.

2. The vehicle access control system according to claim 1, wherein
each of the first access controller, the second access controller, and the third access controller has a policy including a rule related to the message received, and determines whether to transmit the message received, based on the policy.

3. The vehicle access control system according to claim 2, wherein
the third access controller adds, to the message, communication data for use in communication with a destination of the message, and transmits the message.

4. The vehicle access control system according to claim 2, wherein
each access controller among the first access controller, the second access controller, and the third access controller encrypts the message to be transmitted from the segment to which the access controller belongs, to another segment.

5. The vehicle access control system according to claim 2, wherein
by executing the program, the processor is further configured to operate as:
a trigger detector that detects a trigger related to the vehicle; and
a policy manager that manages the policy of each of the first access controller, the second access controller, and the third access controller, wherein
the policy manager changes the policy when the trigger detector detects the trigger.

6. An access control method executed by a vehicle access control system provided in a vehicle, the access control method comprising:
controlling communication in a first area of a segment including a plurality of areas;
controlling communication in a second area of the segment;
controlling communication in a third area different from the first area and the second area through a function to convert the communication protocol; and
causing the third area to relay a message transmitted from the first area to the second area.
